(19) United States
(12) Patent Application Publication
(10) Pub. No.: US 2007/0124684 A1
(43) Pub. Date: May 31, 2007

(54) Automatic power saving in a grid environment

(76) Inventors: Henri Han van Riel, Nashua, NH (US); Lon Hohberger, Nashua, NH (US); Scott Crenshaw, Dunstable, MA (US)

Correspondence Address: MH2 TECHNOLOGY LAW GROUP, 1951 KIDWELL DRIVE, SUITE 550, TYSONS CORNER, VA, 22182, US

(21) Appl. No.: 11/289,400

(22) Filed: Nov. 30, 2005

(51) Int. Cl. G06F 17/00

(52) U.S. Cl. 715/736

(57) ABSTRACT

A global power management for a grid is provided. A grid administrator is connected to the group nodes of the grid. During operation, the grid administrator calculates the cost of operations, such as electricity and cooling costs, and migrates the workload of the grid to minimize the cost of operations. In particular, the grid administrator may deactivate or power down one or more of the nodes in order to minimize the cost of operations.

### DESCRIPTION OF THE INVENTION

1. Field of the Invention

The present invention relates generally to managing power consumption and work-load supported by a group of servers. In particular, the present invention relates to dynamic server power management and dynamic workload management in a grid environment.

2. Background of the Invention

A data center is a facility used for housing a large amount of servers, storage devices, communications equipment, and other related equipment. The servers may be configured in a grid environment or clusters. Such configurations are well known to those skilled in the art. A data center can occupy one or more buildings, which has a well controlled environment. For example, typical data centers have strict requirements or air condition, power, back-up systems, fire prevention, and the like.

Typically, data centers are heavily over-provisioned in order to ensure they can meet their peak demand. However, the majority of time, a server in a data center or grid environment is idle, yet consumes a large amount of power. Indeed, it is common that several servers are performing some tasks that could be performed by a single server at a fraction of the power consumption.

Until recently, little if any attention has been given to managing the power consumed in a data center and the heat generated by data center operations. In general, data center servers have only been concerned with performance and ignored power consumption. Thus, conventional servers for data centers were designed and constructed to run at or near maximum power levels. In addition, as processor and memory speeds in servers have increased, servers are expected to require even more amounts of power. Larger memories and caches in servers also will lead to increased power consumption.

Unfortunately, the infrastructures supporting data centers have begun to reach their limit. For example, it has become increasingly difficult to satisfy the growth requirements of data centers. Recently, high technology companies in some regions were unable to get enough electrical power for their data centers and for the cooling equipment and facilities in which they were housed. In addition, the economic costs associated with operating data centers are becoming significant or prohibitive. Therefore, it is foreseeable that future data centers may need to find ways to reduce their power consumption and operational costs.

Conventional solutions by some server manufacturers have focused on power management of a single node or computer, such as by monitoring certain aspects of a single CPU's operation and making a decision that the CPU should be run faster to provide greater performance or more slowly to reduce power consumption. However, such solutions represent only a partial solution. Conventional solutions fail to provide a systematic way for conserving power for a grid, an entire data center, or a system of data centers.

Accordingly, it would be desirable to provide methods and systems that are capable of controlling a grid or cluster and conserve power. It may also be desirable to globally manage a grid while reducing the power consumption and operational costs of that grid.

### SUMMARY OF THE INVENTION

In accordance with one feature of the invention, a method of optimizing a configuration of a grid of nodes is provided. A workload requested from the grid of nodes is determined. A set of configurations of nodes that satisfy the workload and a cost for each configuration are determined. At least one of the configurations is then selected based on the cost of operations. Nodes are then deactivated based on the selected at least one configuration.

In accordance with another feature of the present invention, a system comprises a grid of nodes and a grid administrator. The grid administrator is configured to monitor the workload requested from the grid of nodes, determine a set of configurations of nodes that satisfy the workload and a cost of operations for each configuration in the set of configurations. The grid administrator then selects at least one of the configurations based on the cost of operations, and deactivate nodes based on the selected at least one configuration.

Additional features of the present invention will be set forth in part in the description which follows, and in part will be obvious from the description, or may be learned by practice of the invention. It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments of the invention and together with the description, serve to explain the principles of the invention. In the figures:

FIG. 1 illustrates an exemplary system that is consistent with embodiments of the present invention; and

FIG. 2 illustrates an exemplary process flow that is consistent with embodiments of the present invention.

### DESCRIPTION OF THE EMBODIMENTS

Embodiments of the present invention provide methods and systems for globally managing the power consumption of a data center or grid environment. For purposes of explanation, the following disclosure describes embodiments of the present invention being applied to a grid environment. However, embodiments of the present invention can be applied to other configurations that may be used in a data center, such as server cluster. It may also be appreciated that although the exemplary embodiments focus attention toward servers, server systems, and power saving features for a grid environment, any type of distributed computer system may benefit from the principles of the present invention.

In a grid environment, a plurality of processing nodes are coupled together in order to service various workloads. Each node may be implemented as a conventional server. The server may include at least one processor or may include multiple processors. The processing nodes may be coupled together in a variety of ways. For example, the nodes may be coupled together over a network, such as the Internet, or a local area network.

In some embodiments, the grid is monitored to determine its current and expected workload. Various configurations of the grid are then determined and compared against the current and expected workload to determine if they meet the workload of the grid. A cost of operation is calculated for each configuration. The cost of operation may factor various factors, such as electrical costs, cooling costs, labor costs, etc. One of the configurations is then selected and implemented in the grid based on the total cost of operation. In some embodiments, the grid is controlled to minimize the cost of operations by concentrating the workload in various nodes of the grid and deactivating those nodes that are considered unnecessary.

Reference will now be made in detail to exemplary embodiments of the invention, which are illustrated in the accompanying drawings. Wherever possible, the same reference numbers will be used throughout the drawings to refer to the same or like parts.

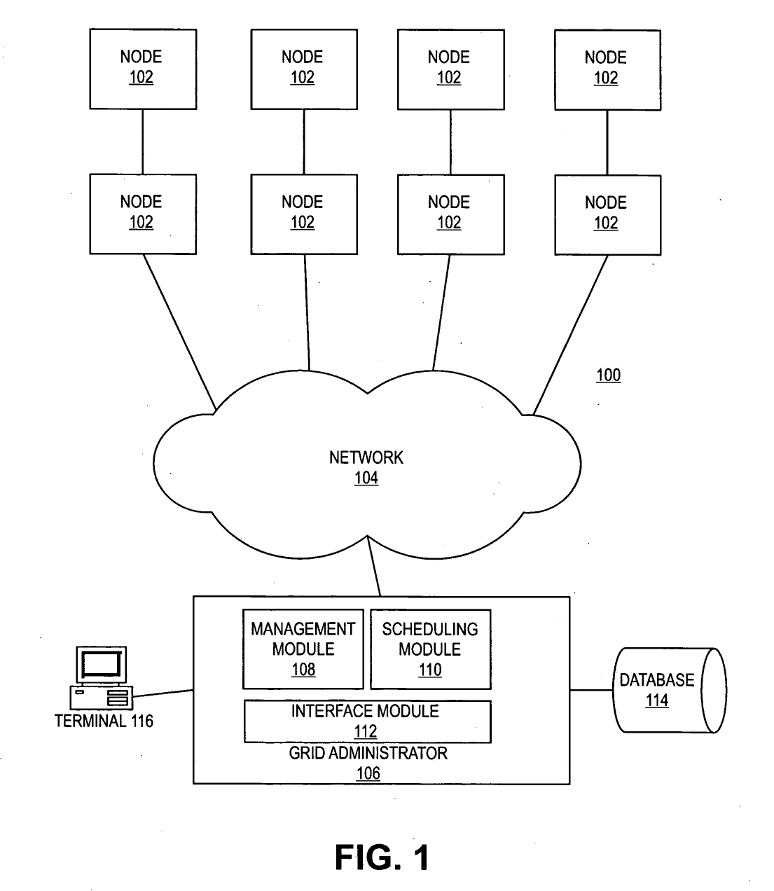

FIG. 1 shows an exemplary grid system 100 that is consistent with embodiments of the present invention. As shown, grid system 100 may comprise a plurality of nodes 102 that are coupled together by a network 104. These components may be implemented using well known hardware and software. For example, nodes may be implemented using well known servers or computers having one or more processors. In addition, nodes 102 may include their own storage devices, such as a hard disk drive or optical drive.

Network 104 provides a communication infrastructure for coupling together nodes 102. Network 104 may be implemented using any form of network, such as a local area network, wide area network, and the like. For example, network 104 may comprise the Internet, an Ethernet network, or a switching fabric. In addition, network 104 may comprise other elements (not shown), such as routers, switches, hubs, firewalls, and the like. Such equipment is well known to those skilled in the art. Thus, one skilled will recognize that nodes 102 may be located in a single facility or data center or distributed across multiple locations.

Grid administrator 106 manages the operations of nodes 102. As shown, grid administrator 106 may be implemented as a central server or computer in grid system 100. Of course, grid administrator 106 may also be implemented in a distributed manner over several machines.

In general, grid administrator 106 is configured to monitor and evaluate the current status of nodes 102, schedule workloads (or portions of workloads) to nodes 102, collect workload results from nodes 102, package the results from nodes 102 for delivery to the workload requester. Grid administrator 106 may also contain all of the relevant information with respect to the grid's topology, processor capacity for each of nodes 102, available memory for each nodes 102, I/O controller assignments for each node 102, and the like.

In order to perform the above mentioned functions, grid administrator 106 may comprise a management module 108, a scheduling module 110, and an interface module 112. In addition, grid administrator 106 may be coupled to a database 114. These components will now be further explained.

Management module 108 is responsible for controlling and setting up nodes 102 to service the workloads requested. For example, management module 108 is responsible for assigning I/O controllers to nodes 102, and monitoring the operation of all the other equipment (not shown) in system 100, such as storage devices, cooling equipment, and the like.

In addition, management module 108 provides a mechanism for migrating workloads across nodes 102. This may be done by stopping the workload on one node and starting it on the other node, or by live process migration. For example, if the demand for computing resources exceeds what is currently available on a node, then management module 108 may migrate the workload to another node or share the workload with multiple nodes 102. Management module 108 may migrate workloads based on network bandwidth available to a node, where workloads are being requested (such as the locations of website users), where workloads will have the best service levels or service level agreements, or where nodes 102 have the most administrative capacity. Other known ways of migrating workloads may also be implemented management module 108.

In some embodiments, if management module 108 detects excess capacity or that workloads can be consolidated, then management module 108 may concentrate the workloads onto a set of nodes 102 (called “active” nodes) and power down nodes that are unnecessary (“inactive” nodes). Of course, management module 108 may utilize a buffer or “headroom” in order to avoid repetitive cycling of nodes 102. When workload demand of grid system 100 exceeds the capacity of active nodes, then management module 108 may reactivate a number of inactive nodes.

Management module 108 may also employ anticipatory reactivation based on various factors. For example, management module 108 may consider the time needed to power and start up a particular node. Management module 108 may also refer to recent workload trend information and extrapolate an expected workload for the near future, such as workload expected within the next hour. Management module 108 may also consider trend information, such as seasonal or daily histories of workload activity to determine the number of active versus inactive nodes. For example, the history of grid system 100 may be that utilization of nodes 102 rises from 30% to 50% at 9:00 AM on weekdays. Accordingly, management module 108 may use anticipatory reactivation at 8:55 AM in preparation for the expected increase in deniand.

Management module 108 may also use anticipatory deactivation. For example, the history of grid system 100 may be that utilization of nodes 102 typically drops at 5:00 PM. In response, management module 108 may determine that fewer nodes 102 are needed and deactivate some of nodes 102. Management module 108 may also use this information as a basis for using a smaller buffer or headroom of excess capacity. For example, if workload increases at 4:55 PM, then management module 108 may elect not to reactivate any of nodes 102, since workload is generally expected to decrease around 5:00 PM. Of course, management module 108 may also use recent trend information to extrapolate an expected workload demand for the near future when deciding whether to deactivate one or more of nodes 102.

As noted, management module 108 is responsible for the global or general power management of grid system 100. In particular, management module 108 may be capable of powering any of nodes 102 off, powering any of nodes 102 on, or powering any of nodes 102 to intermediate states that are neither completely on nor completely off, that is, “sleep” or “hibernate” states. Management module 108 may determine the configuration of nodes 102 based on economic costs in order to reduce the total cost of operations of grid system 100. For example, management module 108 may determine which of nodes 102 are powered off or-on based on electrical costs, cooling costs, labor costs, etc. Management module 108 may also consider other cost, such as service costs, equipment purchasing costs, and costs for space for nodes 102. Accordingly, management module 108 may automatically shift workloads to nodes 102 where electricity costs are cheaper for that time of day.

Scheduling module 110 operates in conjunction with management module 108 to schedule various portions of workloads to nodes 102. Scheduling module 110 may use various algorithms to schedule workloads to nodes 102. For example, scheduling module 110 may use algorithms, such as weighted round robin, locality aware distribution, or power aware request distribution. These algorithms are well known to those skilled in the art and they may be used alone or in combination by scheduling module 110. Of course, scheduling module 110 may use other algorithms as well.

Interface module 112 manages communications between grid administrator 106 and the other components of system 100. For example, interface module 112 may be configured to periodically poll nodes 102 on a regular basis to request their current status and power usage. Interface module 112 may be implemented based on well-known hardware and software and utilize well-known protocols, such as TCP/IP, hypertext transport protocol, etc. In addition, interface module 112 may be configured to receive workload requests and results from nodes 102. Interface module 112 may also provide results to the workload requester after they have been packaged by management module 112.

A human administrator (not shown) may use interface module 112 to control grid administrator 106. For example, as shown, a terminal 116 may be coupled to interface module 112 and allow a human administrator to control the operations of grid administrator 106. Of course, terminal 116 may be locally or remotely coupled to interface module 112.

Database 114 comprises various equipment and storage to serve as a repository of information that is used by grid administrator 106. Such equipment and storage devices are well known to those skilled in the art. For example, database 114 may comprise various tables or information that tracks the inventory of nodes 102 in grid system 100, such as their various characteristics like processor architectures, memory, network interface cards, and the like. In addition, database 114 may include information or tables that archive various histories of grid system 100. These histories may include power consumption histories, cost histories, workload histories, trend information, and the like.

The information in database 114 may be automatically collected by grid administrator 106 or may be periodically entered, such as by a human administrator or operator. For example, nodes 102 may each contain one or more software agents (not shown) that collect status information, such as processor utilization, memory utilization, I/O utilization, and power consumption. These agents may then provide this information to grid administrator 106 and database 114 automatically or upon request. Such agents and the techniques for measuring information from nodes 102 are well known to those skilled in the art.

Database 114 may comprise a history of electricity costs. These costs may vary according to the time of day, time of year, day of the week, location, etc. In addition, database 114 may also include information that indicates cooling costs. Cooling costs may be the electricity costs associated with powering cooling equipment, such as fans and air conditioners. Furthermore, database 114 may comprise a history of information that indicates personnel or labor costs associated with various configurations of nodes 102. Again, these costs may vary according to the time of day, time of year, day of the week, location, etc. One skilled in the art will also recognize that other types of costs (economic or non-economic) may be stored in database 114. For example, database 114 may comprise information that indicates service level agreements, administrative capacity, etc., for nodes 102.

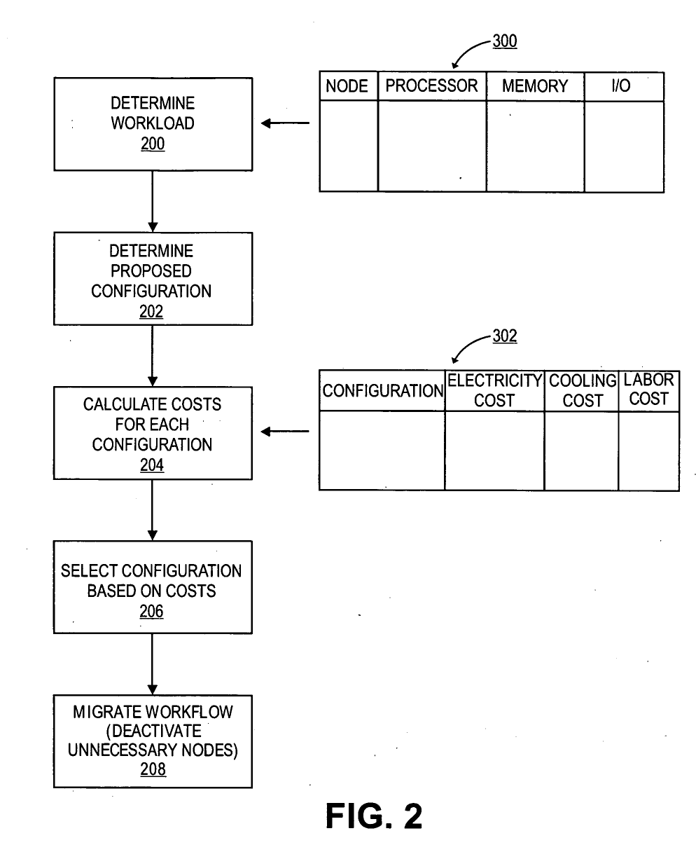

FIG. 2 shows an exemplary process flow that is in accordance with embodiments of the present invention. In stage 200, grid administrator 106 monitors the workload of grid system 100 and determines the workload requested from nodes 102. For example, management module 108 may monitor the workload of grid system 100 using well known load monitoring technology. Management module 108 may maintain status information in database 114 as it is monitoring the workload. For example, as shown in FIG. 2, management module 108 may maintain a table like table 300 in database 114. In the example shown, table 300 may maintain for each of nodes 102 information that indicates the status of processor utilization, memory utilization, and I/O utilization. This information may later be utilized by management module 108 to determine which configurations of nodes 102 will satisfy the requested workloads.

When determining the workload requested from nodes 102, management module 108 may consider the current workload as well as anticipated workload. For example, as noted above, management module 108 may refer to table 300 to determine the current status of workload requested from nodes 102. In addition, management module 106 may query database 114 to determine the history of workloads. Based on this history, management module 106 may then determine the expected change (if any) for the workload. Management module 106 may base this determination on various windows, such as minutes, hours, days, etc. Once management module 106 has determined the workflow (current and/or expected) requested from nodes 102, processing may then flow to stage 202.

In stage 202, grid administrator 106 determines various proposed configurations that can satisfy the workload (current and/or expected). In particular, grid administrator 106 may evaluate the capabilities of each of nodes 102 and determine a set of nodes 102 that can satisfy the workload. For example, the requested workload may be parsed in terms of processor workload, memory workload, and I/O workload.

Management module 106 may then determine if some or all of the workload can be concentrated onto various numbers of nodes 102. For example, management module 106 may query database 114 to determine the current status and capacities of each of nodes 102. Based on these individual capacities, management module 106 may generate various combinations or sets of nodes 102 that can satisfy the workload. Management module 106 may begin by determining a minimum number of nodes 102 that can satisfy the workload and progressively determine combinations having an increasing number of nodes 102. Of course, management module 106 may also consider other factors, such as the proximity of nodes 102 to where the requested workflow originated, service level agreements associated with any of nodes 102, network bandwidth available to each of nodes 102. Processing may then flow to stage 204.

In stage 204, grid administrator 106 determines a cost of operations for each proposed configuration. For example, in some embodiments, management module 106 may determine electricity costs, cooling costs, and personnel costs for each configuration. Table 302 is shown in FIG. 2 to provide an illustration of how management module 106 may format this information. Management module 106 may also determine other costs, such as location costs, and may aggregate one or more of the costs.

In order to determine the cost of operations, management module 106 may query information from database 114. As noted, such information may vary by location and time. Accordingly, management module 106 may also organize cost information based on time and location of the requested workload.

In stage 206, grid administrator 106 selects one of the proposed configurations. In some embodiments, management module 106 may select configurations that minimize the cost of operations. Management module 106 may select a configuration based on an individual cost, such as electricity costs, or based on a combination or aggregate of multiple costs, such as electricity costs, cooling costs, and personnel costs.

Management module 106 may also utilize a buffer or headroom when selecting a configuration. For example, management module 106 may select a configuration of nodes 102 that provide some capacity that is in excess of the current requested workload. The buffer or headroom used by management module 106 may be a fixed amount or dynamic according to parameters, such as time of day or location. For example, management module 106 may use a lower headroom in the evenings because workloads in the evening may have a history of being relatively steady. As another example, management module 106 may use a lower headroom when one or more nodes 102 are located in a facility with significant administrative support, such as technical staff or monitoring systems.

Management module 106 may select a configuration based on load balancing concerns. For example, management module 106 may select a configuration that concentrates the workload on relatively few of nodes 102. Alternatively, management module 106 may select a configuration that spreads the workload on a slightly higher number of nodes 102 in order to maximize performance or to anticipate an increase in the workload.

Management module 106 may also select a configuration based upon load monitoring data to predict when extra (or less) capacity may be needed from nodes 102. Management module 102 may determine this prediction based on information retrieved from database 114. Thus, management module 106 may select a configuration that proactively reactivates various nodes 102 in anticipation of an expected workload increase and vice versa.

Management module 106 may select a configuration based on an extrapolation from the current workload. For example, management module 106 may analyze the workload within a recent window, such as minutes, hours, or days, and calculate an extrapolated workload from this information. Processing may then flow to stage 208.

In stage 208, grid administrator 106 migrates the workload (if necessary) and deactivates one or more nodes 102 that are no longer necessary. Upon selecting a configuration, grid administrator 106 may then take various actions to migrate the workload to some of nodes 102 and may deactivate those of nodes 102 that are considered unnecessary by powering them down. In particular, management module 108 may generate various configuration commands that are to be sent to nodes 102. In turn, these commands are processed by scheduling module 110 and eventually transmitted by interface module 112 to nodes 102.

In response, nodes 102 may selectively deactivate or activate based on the commands from grid administrator 106. Other management tasks, such as an acknowledgement message or a message that reports status information, may also be part of the response of nodes 102. The mechanisms and software in nodes 102 to perform these functions are well known to those skilled in the art.

Grid administrator 106 may also obtain approval from some or all of the other nodes 102 when it initiates a deactivation or power-down action in nodes 102. Such approval may be used in order to account for contingencies, such as a power failure, or equipment failure in one or more of nodes 102. Accordingly, grid administrator 106 may modify its selected configuration request if it determines that powering down a node 102 may cause grid system 100 to become unable to meet the current workload, such as in the event of an unexpected spike or a power failure. Of note, the sequence of events described above is specific to a power-down operation and it is merely an illustrative example. The actions taken by grid administrator 106 may depend on the nature of the power management request. Different types of power management requests may cause different sequences of events. Processing may then repeat back to stage 200.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of optimizing a configuration of a grid of nodes, said method comprising:
determining a workload requested from the grid of nodes;
determining a set of configurations of nodes that satisfy the workload;
determining a cost of operations for each configuration in the set of configurations;
selecting at least one of the configurations based on the cost of operations; and
deactivating nodes based on the selected at least one configuration.

2. The method of claim 1, wherein determining the workload requested from the grid of nodes comprises:
determining a trend of the workload based on a history of previous workloads; and
determining an anticipated change in the workload based on the trend.

3. The method of claim 1, wherein determining the set of configurations of nodes that satisfy the workload comprises determining a minimum number nodes that can satisfy the workload.

4. The method of claim 1, wherein determining the set of configurations that satisfy the workload comprises:
determining a location from which the workload is being requested; and
determining the set of configurations that satisfy the workload based on nodes that are in proximity to the location.

5. The method of claim 1, wherein determining the set of configurations that satisfy the workload comprises:
determining service level agreements associated with the nodes; and
determining the set of configurations that satisfy the workload based the service level agreements.

6. The method of claim 1, wherein determining the cost of operations for each configuration comprises determining a cost of electricity for each configuration.

7. The method of claim 1, wherein determining the cost of operations for each configuration comprises determining a total of multiple costs for each configuration.

8. The method of claim 1, wherein determining the cost of operations comprises determining a cost of cooling for each configuration.

9. The method of claim 1, wherein determining the cost of operations comprises determining a cost of labor for each configuration.

10. The method of claim 1, wherein selecting at least one of the configurations based on the cost of operations comprises selecting a configuration having the lowest cost of operations.

11. The method of claim 1, wherein selecting at least one of the configurations based on the cost of operations comprises:
determining a desired amount of capacity in excess of the workload; and
selecting at least one of the configurations based on the desired amount excess capacity and the cost operations.

12. The method of claim 1, wherein deactivating nodes based on the selected at least one configuration comprises:
determining nodes that are unnecessary to the selected at least one configuration; and
powering down the unnecessary nodes.

13. The method of claim 1, further comprising:
identifying an expected increase in the workload requested from the nodes; and
reactivating at least some of the deactivated nodes based on the expected increase.

14. A computer readable medium comprising computer executable instructions for performing the method of claim 1.

15. An apparatus configured to perform the method of claim 1.

16. A system comprising:
a grid of nodes configured to satisfy requested workloads; and
a grid administrator configured to monitor the workload requested from the grid of nodes, determine a set of configurations of nodes that satisfy the workload, determine a cost of operations for each configuration in the set of configurations, selecting at least one of the configurations based on the cost of operations, and deactivate nodes based on the selected at least one configuration.

17. The system of claim 16, wherein the grid administrator is configured to determine the cost of operations for each configuration based on electricity costs for each configuration.

18. The system of claim 16, wherein the grid administrator is configured to determine the cost of operations for each configuration based on cooling costs for each configuration.

19. The system of claim 16, wherein the grid administrator is configured to determine an expected increase in the workload requested from the grid of nodes and reactivate at least some of the nodes based on the expected increase in the workload.

20. The system of claim 16, wherein the grid administrator is configured to determine a desired amount of capacity in excess of the workload and select at least one of the configurations based on the desired amount excess capacity and the cost operations.
